(19) United States
(12) Patent Application Publication
(10) Pub. No.: US 2017/0076362 A1
(43) Pub. Date: Mar. 16, 2017

(54) Future Kicks

(71) Applicant: Zachary Joyner, Wahiawa, HI (US)

(72) Inventor: Zachary Joyner, Wahiawa, HI (US)

(21) Appl. No.: 14/851,029

(22) Filed: Sep. 11, 2015

(51) Int. Cl. G06Q 30/06

(52) U.S. Cl. CPC G06Q 30/0643

(57) ABSTRACT

A smart phone shopping application, particularly for buying shoe and like products is disclosed. The shopping application displays the 3D image of the shoes, and provides the related description of the shoe product. The user gets information on new shoes and also sells/trades and/or buys shoes through this app, for which a tab is provided. The shopping application also comprises various filters within to provide option while utilizing the app, and thus is compatible and convenient to use.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention is directed to the field of websites and mobile/smartphone applications. Specifically, this invention relates to a mobile application, and more specifically, to a shopping app, particularly for shoes, displaying the 3D pictures with related information of the product.

(2) Background of Invention

Today, online clothing shopping through websites, tablets and smart phone apps tends to be a very sequential and tedious process. Just in the area of shopping for shoes alone, every store website displays their articles grouped in footwear categories of men, women, kids, shoes, sandals, slippers, etc. This type of presentation tends to make it hard to visualize how the footwear looks into the one's feet.

While online marketing and selling industries typically sell around 50% of their yearly sales online and book sellers sell about 40% of their sales online, online sales of apparel and footwear comprises only 10% of total industry sales due to a few factors but primarily is due to the difficulty in sizing.

Consumers are fearful of buying apparels and footwears they cannot try on because they are not certain that it will fit them well. But what if the consumer knew that he could easily find footwears that fit him well online without trying it on for size? Some inefficient solutions to the problem of shopping for clothes online without trying the footwears on include 3D body scanners and virtual fitting rooms. The problem with 3D body scanners is that the consumer has to travel to a specific location to get body scanned and then upload his scanned information online, which is not compatible with most shopping sites. The problem with virtual fitting rooms is that a cartoon or avatar representation of the consumer is inaccurate and difficult to work with when it comes to sizing.

Another solution to sizing footwears online is to ask the user which brands and fits already fit the user best and then to estimate which other similar fitting brands might fit the user. The problem with this solution of cross matching various brands is several folds. First, it is noted that the cut, fit, and size of the items within the brand constantly changes without a universal or uniform guide. Second, different materials such as leather, canvas, etc. fit differently even within the same products over time and in different environments. Third, the user cannot easily and accurately find the best size for the user or which brands fit the user best because of the lack of accuracy, precision, and unaccounted variables of this inefficient method.

A prime reason that people return footwears purchased from the internet is because of inaccurate sizing; in fact 60% of online sales are fit related. Another prime reason is that people purchase multiple sizes of the same item, try them on, and return the products that don't fit. This process creates a net loss for the businesses and the economy. Every footwears company has a different size chart or set of measurement sizes for each of their items which convolute the consumer's ability to understand what size he or she is. This complicated and inefficient system of sizing creates a demand for a solution that can provide for accurate sizing. Also, international standards and systems for measurement make the problem worse. Also, each brand is designed to fit a particular user's type best but consumers do not know which brands fit them best.

Accordingly, a need remains for a shopping app which provides a clear picture of the footwear product with their related description and the like.

As such, it may be appreciated that there continues to be a need for a new and improved mobile application as set forth by the instant invention which addresses the problems of ease of use as well as effectiveness in construction in providing the shopping related app for use in providing clear picture and the related description of the product and in this respect, the present invention substantially fulfills this need.

### BRIEF SUMMARY OF THE INVENTION

In view of the foregoing disadvantages inherent in the known types of shopping websites and mobile applications now present in the prior art, the present invention provides smart phone application wherein the same provides for a shopping related app, particularly for footwears and use on process of various components employed in the procedure. As such, the general purpose of the present invention, which will be described subsequently in greater detail, is to provide a new and improved smart phone application which has all the advantages of the prior art and none of the disadvantages.

Accordingly, it is a primary aspect of the present invention to provide a shopping application for a smart phone which tends to display the 3D image of the shoes.

In another aspect, the present invention provides a smart phone application that provides the related description of the shoe product.

It is yet another aspect of the present invention where the user gets information on new shoes and also sells/trades and/or buys shoes through this app.

Additionally, this app also connects, and thereby provides a social haven for people all over the world to discuss shoes amongst each other.

Further aspect of the present invention provides a new release pictures of shoes scheduled to come out later on in the year.

In yet another aspect, a tab for buy/sell and trade shoes is provided in the inventive smart phone application. Also, a tab is provided for social media within the site.

It is still another aspect of the present invention to provide a new and improved smart phone application which may be easily and efficiently provides a platform to market the shoe products.

It is a further aspect of the present invention to provide a new and improved smart phone application which is very reliable to use and is compatible with most online shopping providers.

Other aspects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting.

These together with other aspects of the invention, along with the various features of novelty which characterize the invention, are pointed out with particularity in the disclosure. For a better understanding of the invention, its operating advantages and the specific objects attained by its uses, reference should be had to the accompanying descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a perspective view of the graphical user interface of the shopping application[;]

FIG. 2 is a 360° perspective view of the shoe product[;]

FIG. 3 illustrates multiple searchable area in the graphical user interface of the mobile application.

### DETAIL DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. However, it will be apparent to one skilled in the art that the present invention may be practiced without the specific details. In other instances, well-known features are omitted or simplified in order not to obscure the illustrative embodiments.

The description that follows includes exemplary devices, methods, memory, systems, techniques, instruction sequences and computer program products executed on a processor of a mobile device that embody techniques of the present inventive subject matter. However, it should be understood that the described embodiments may be practiced without these specific details. Well-known instruction instances, protocols, structures and techniques have not been shown in detail in order not to obfuscate the description.

The inventive subject matter includes devices, methods, memory, processor for executing instruction or computer programs and systems utilizing mobile technology such as, mobile wireless communication, telecommunication, data storage, online transactions, mobile software development and touch screen mobile devices and the like. The technology can be used in conjunction with mobile devices, such as but limited to the mobile phone devices, smartphone, communication devices, computer, PDA (Personal Digital Assistant), tablet and the like.

In some preferred embodiments, the systems, methods and/or techniques of a shopping related mobile application are disclosed. A shopping portal application may reside and execute on an electronic device e.g., a mobile device, smartphone, communication devices, computer, PDA (Personal Digital Assistant), tablet and the like. The application allows the user to search and select a product from a database by communicating with a server via wireless communication such as internet. Further, the database includes a 360 degree picture or image of the products. Further, the mobile application is adapted to show the 360 degree image of the products in in three dimensional views, such that the user can manipulate the view of the 360 degree image of the products at different angle to get a full view of the product, shoe herein. The application thereby also provides the related description of the shoe product, where the user gets information on new shoes and also sells/trades and/or buys shoes through this app.

In accordance with the invention, the mobile application is adapted to provide the new release pictures of upcoming product, upcoming shoes herein, is scheduled to come out later on in the year. Further, the mobile application includes a graphical user interface & button or tab (not shown) for buy/sell and trade the product i.e. shoes or footwear. Further, the mobile application includes a graphical user interface button or a tab for social media (not shown) which allows the user to share the user desired products on social media networking platforms a graphical user interface tub tab or button for latest rumor spread for the products or shoes and a graphical user interface tab for where people can verify their own shoes with more knowledgeable people to tell whether their shoes are real of fake. It is basically a 360 degree image of new or upcoming product, shoes herein, which is scheduled to come out in future. Also, the application is furnished with the real information about the shoes coming from the designers of the shoes.

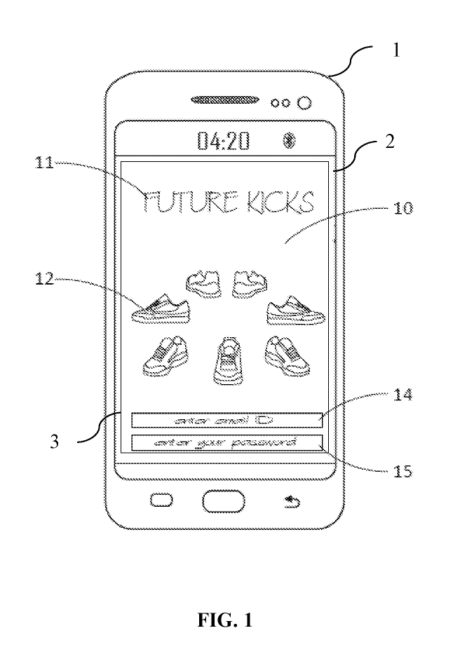

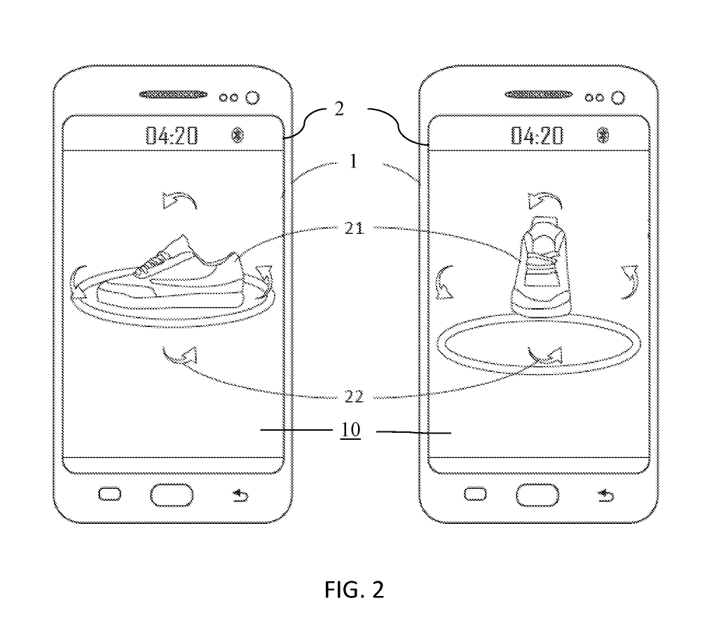

With reference now to the drawings, and in particular to FIGS. 1 and 2 thereof, a new and improved shopping application embodying the principles and concepts of the present invention are described herein.

Referring to FIG. 1, an embodiment of the present invention, there is shown a graphical user interface 10 of the present shopping related mobile application 3 running on a mobile device 1, which allows a user (not shown) to access the mobile application 3 for searching and purchasing the upcoming product. The graphical user interface 10 represents the application logo 11, “Future Kicks”, followed by the product images 12 displayed on screen 2 of the mobile device 1. Further, the mobile application 3 is accessible by the user after entering the user's credentials such as the email ID and password in the provided graphical user interface tabs 14 and 15 respectively.

Further, the FIG. 2 diagrammatically illustrates a user selected product with the 360 degree product image 21 of the product in three dimensional view. The 360 degree product image 21 as it would be seen on the screen 2 display device 1. The 360 degree product image 21 in web store or application can be picked up by the user and rotated to see all sides of product image 21 by using input means 22 provided in the mobile application. Further, the at least one input means 22 allows a user to rotate the 360 degree product image 21 from left to right, up/down and vice versa up to 360 degree. The user may appear to carry the product image 21 or may have a virtual shopping cart where one can drag and drop product image 21.

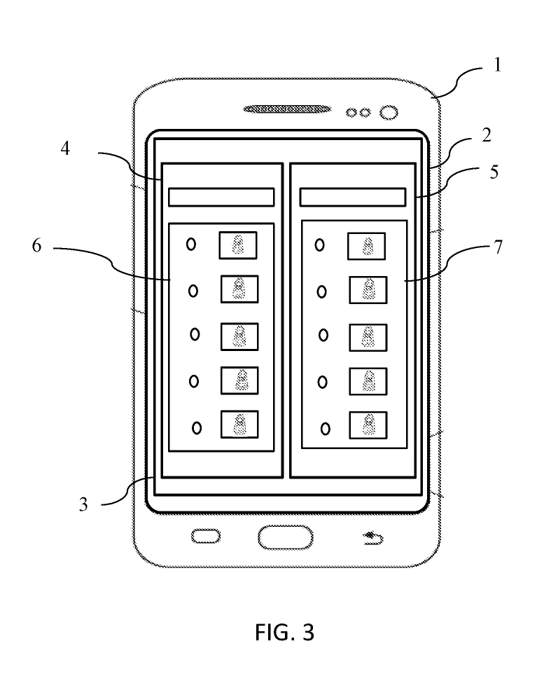

Referring to FIG. 3, In one embodiment, the mobile application 3 is adapted to partition the graphical user interface displayed on the screen 2 of the electronic device 1 into separately searchable areas 4, 5 (e.g. rows, columns, etc.). Within each searchable area 4 and 5, the mobile application 3 is adapted to display the product items 6,7 that may relate to a composite product. In another embodiment, the shopping portal mobile application may access data regarding the related product items searched in each searchable area 4,5 from the database by communicating with the server (not shown) via wireless communication. Further, the shopping application 3 is adapted to display into a plurality of separately searchable areas 4,5. For example, the mobile application 3 is adapted to display first related product items 6 into a first separately searchable area 4 and display second related product items 7 into a second separately searchable area 5. Further, the shopping application is adapted to bring search first and second related product items into proximal to each other, so that the user can take additional action (e.g. buying products, writing reviews, comparing etc.).

In another embodiment system and/or methods are disclosed for providing discovery and guidance for online shopping, and closet organization through an application of an electronic device connected to a server and database. For example, the server and database that the electronic device is connected to can connect with one or more web stores, affiliates, or designers to receive data reflecting their online merchandise through internet via wireless communication.

In further embodiments, the mobile application 3 can provide functions to filter and refine the online merchandise received from multiple stores, affiliates, or designers to create different applications customized for different consumer demographics including but not limited to women's footwear, men's footwear, children's footwear, and the likes.

In some embodiment, the application can provide functions to attract a user to view the latest styles from stores, designers, and bloggers. For example, through the application, a user can be provided with a look book of rich media content that promotes store brands, designer brands, bloggers, and additionally serves advertisements. In some embodiments, the application can allow the user to select a promotion or advertisement to display mini look books of multi-page content or video brand campaigns, blogger content or advertisements. In some embodiments, the application can allow the user to store content from the look books. For example, a user can tap on a product image in the look book and the user will be informed that the product information has automatically been added to the user's favorites to acquire the related information.

Further, this app also connects, and thereby provides a social haven for people all over the world to discuss shoes amongst each other.

As may now be appreciated from the above description, the present invention provides a shopping application for a smart phone device which may be utilized by the user to view the images and get the related information of the product, shoe herein.

It is to be understood that the above description is intended to be illustrative, and not restrictive. For example, the above-discussed embodiments may be used in combination with each other. Many other embodiments will be apparent to those of skill in the art upon reviewing the above description.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

It is to be understood that the above description is intended to be illustrative, and not restrictive.

1-6. (canceled)

7. A method for providing a 360 degree view of a product by accessing a mobile application having a graphical user interface, wherein said mobile application is running on a processor enabled mobile device, comprising:
selecting at least one searchable area from said graphical user interface of said mobile application via said mobile device;
searching at least one product through said selected at least one searchable area of said graphical user interface from a database;
displaying said at least one product in said selected at least one searchable area of said graphical user interface;
selecting said at least one product with said 360 degree image from said at least one searchable area of said graphical user interface;
displaying a 360 image of said selected product;
providing an input means allowing a user to manipulate a view of said 360 image.

8. The method as claimed in claim 1, wherein said mobile device is selected from a group of a smartphone, tablet, computer, PDA and communication device and the combination thereof.

9. The method as claimed in claim 1, wherein at least one searchable area is an graphical user interface to receive a search inputs from said user via said mobile device.

10. The method as claimed in claim 1, wherein said database includes a plurality of 360 degree image of said at least one product.

11. The method as claimed in claim 1, wherein said database is adapted to communicate with said mobile device via a server through wireless communication.

12. The method as claimed in claim 1, wherein said inputs means is an executable software program that allows said user to change said view at different angles via said graphical user interface of said mobile device.

13. The method as claimed in claim 6, wherein said inputs means adapted to rotate said 360 degree image of said selected product from left to right, up/down and vice versa up to 360 degrees in three dimensional representation.
